(19) United States
(12) Patent Application Publication
(10) Pub. No.: US 2006/0055249 A1
(43) Pub. Date: Mar. 16, 2006

(54) Power switching device in mobile communication terminal

(75) Inventor: Woong-Gil Choi, Gyeonggi-Do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/213,782

(22) Filed: Aug. 30, 2005

(30) Foreign Application Priority Data
Aug. 31, 2004 (KR) 69338/2004

(51) Int. Cl. H01H 85/46

(52) U.S. Cl. 307/139

(57) ABSTRACT

A power switching device in a mobile communication terminal includes a voltage regulator configured to generate a first voltage to be used as an input to a power amplifier module, a battery configured to output a second voltage to be used as the input to the power amplifier module, and a load switch configured to switch from using the first voltage to using the second voltage as an input to the power amplifier module based on an output power level of a transmit signal of the terminal.

### CROSS-REFERENCE TO A RELATED APPLICATION

The present application claims priority to Korean Application No. 69338/2004 filed on Aug. 31, 2004, the entire contents of which is incorporated by reference.

### BACKGROUND OF THE INVENTION

1. Field of the Invention

The present invention relates to a mobile communication terminal, and more particularly to a power switching device in a mobile communication terminal capable of switching power applied to a power amplifier module at a high speed.

2. Description of the Related Art

In general, a mobile communication terminal (hereinafter, referred to as a terminal) that has subscribed to a mobile communication system performs radio communication with another party through a communication network established by a mobile switching center within a service region. Further, a terminal near a base station generally outputs a transmit signal using a lower output power, while a terminal farther from the base station amplifies and outputs a transmit signal using a higher output power.

The power control method of the terminal is typically performed by controlling a level of input power supplied to a power amplifier module (PAM) based on an output of the PAM or by performing inner loop power control. Further, the PAM generally consumes a large amount of current in the terminal, and accordingly its power is switched at high speed to provide a stable power supply and to minimize a power consumption thereof.

Turning now to FIG. 1, which is a schematic view showing a power switching device of a related art mobile communication terminal. As shown, the related art power switching device includes a voltage regulator 10 for regulating a level of an output Vdd of a battery, and a first load switch 11 for transferring an output voltage Vout-dc of the voltage regulator 10 as a supply voltage Vpam of the PAM according to a switch enable signal SEN1. Also included is a second load switch 12 for transferring the battery voltage Vdd as the supply voltage Vpam of the PAM according to a switch enable signal SEN2, and a power decoupling unit 13 for removing noise from the supply voltage Vpam. Further, reference symbols L1 and C1 denote an inductor and a capacitor (condenser), respectively, which form a smoothing unit for smoothing the output voltage Vout-dc.

In addition, the voltage regulator 10 is a DC-DC converter including two field effect transistors (FET1 and FET2) and one controller 10-1. The controller 10-1 controls the FET1 and FET2 to regulate the level of the output voltage Vout-dc. The first and second load switches 11 and 12, as shown in FIG. 2, include a FET3 turned on by the switch enable signal SEN1 or SEN2, and a FET4 which turns on when the FET3 is turned on so as to transfer the output voltage Vout-dc or the battery power Vdd to an output terminal 50. In this example, the FET3 is an n-type FET, and the FET4 is a p-type FET. Further, as shown in FIG. 1, the power decoupling unit 13 includes three power decoupling capacitors (condensers) C2 to C4.

An operation of the above-noted power switching device will now be explained.

Power switching involves supplying one of two different voltages as the supply voltage of the PAM based on the conditions of the terminal (or channel conditions). The Vout-dc and the battery voltage Vdd used for power switching are shown in FIG. 1. The Vout-dc is an output voltage of the voltage regulator 10, in which the controller 10-1 generates a Vout-dc of 1.5V, for example, which is voltage-dropped from the battery voltage Vdd of 4V, for example, by appropriately adjusting the frequencies of the FET1 and FET2. The corresponding Vout-dc is then smoothed by the smoothing unit, namely, the inductor L1 and the capacitor C1, and is input into the first load switch 11.

Therefore, the first and second load switches 11 and 12 supply the output voltage Vout-dc of the voltage regulator 10 or the battery voltage Vdd as the supply voltage Vpam of the PAM according to the switch enable signals SEN1 or SEN2. In addition, an MPU (Microprocessor Unit) of the terminal determines the values of the switch enable signals SEN1 and SEN2 by considering, for instance, a channel condition and a (physical) distance between the terminal and the base station. That is, as shown in the flowchart of FIG. 3, when transmitting a radio signal to the base station, the MPU checks the distance between the terminal and the base station by performing an inner loop power control method, and then determines whether to maximize the output power of the PAM (S10 and S20).

When the terminal is far from the base station, which generally requires signals be transmitted at a maximum output power, the MPU turns on the second load switch 12 so as to supply the Vdd of 4V as the PAM voltage Vpam (e.g., SEN1 at a low level, and SEN2 at a high level) (S30). On the contrary, when the terminal is close to the base station, which generally requires signals be transmitted at a normal or lower output power, the MPU turns on the first load switch 11 so as to input the Vout-dc of 1.5V as the PAM voltage Vpam (e.g., SEN1 at a high level, and SEN2 at a low level) (S40 and S50).

In this instance, the first and second load switches 11 and 12, as shown in FIG. 2, are turned on when the FET4 is turned on by the switch enable signals SEN1 and SEN2 having low levels. When the FET4 is turned on, the FET3 is also turned on due to the ground of FET3.

As noted above, either the Vout-dc of 1.5V or the Vdd of 4V, for example, is supplied as the PAM voltage Vpam through the output terminal 50 according to the levels of the switch enable signals SEN1 and SEN2 output from the MPU. Further, the power decoupling capacitors C2 to C4 of the power decoupling unit 13 are connected in parallel to the output terminal 50, and remove noise from the voltage Vpam applied to the PAM. Thus, the power of the PAM can be supplied in a stable manner. Therefore, the PAM amplifies a radio (wireless) signal based on the voltage Vpam input through the terminal 50, and transmits the amplified signal to the base station (S60 in FIG. 3).

However, when the power of the PAM is switched using the power decoupling capacitors in the related art device, the electrostatic capacity of the power decoupling capacitors causes problems in the device. Thus, in situations where inner loop control characteristics must be satisfied, such as in a CDMA or WCDMA, the related art power control method may not be appropriately performed.

For example, when the supply voltage Vpam of the PAM is supplying 4V and switching is required to supply a lower voltage of 1.5V, the voltage of the output terminal 50 is discharged. Thus, the power switching speed is increased according to the time needed for the discharging. More particularly, until the voltage charged in the capacitors C2 to C4 is completely discharged, the voltage at the output terminal 50 does not fall below the Vout-dc of 1.5V. That is, because the discharging time depends on the electrostatic capacity of the power decoupling capacitors C2 to C4, when an on/off time of each FET within each load switch 11 and 12 is assumed to be ‘t’, a total switching time of the related art power switching device is increased by as much as 4t+(discharging time of the capacitors C2, C3 and C4).

Furthermore, in the related art, when the first load switch is enabled to maintain the PAM supply voltage of 1.5V, a reverse current (i.e., a reverse discharge toward the first load switch) may be generated due to the power decoupling capacitors C2 to C4, and a reverse voltage generated from the terminal 50 (or the input terminal of the PAM) is leaked toward the voltage regulator 10, thereby resulting in distortion of the output of the voltage regulator 10.

### SUMMARY OF THE INVENTION

Therefore, an object of the present invention is to provide a power switching device in a mobile communication terminal capable of performing high speed power switching using a simple structure.

Another object of the present invention is to provide a power switching device in a mobile communication terminal capable of performing stable power switching and stable current supply by preventing a reverse current and a reverse voltage from being generated during a power switching operation.

To achieve these and other advantages and in accordance with the purpose of the present invention, as embodied and broadly described herein, the present invention provides a power switching device in a mobile communication terminal including a voltage regulator configured to generate a first voltage to be used as an input to a power amplifier module, a battery configured to output a second voltage to be used as the input to the power amplifier module, and a load switch configured to switch from using the first voltage to using the second voltage as an input to the power amplifier module based on an output power level of a transmit signal of the terminal.

The power switching device further includes a power decoupling unit connected between the battery and the load switch and configured to remove noise from the second voltage input into the load switch, a smoothing unit connected at an output of the voltage regulator and configured to smooth an output voltage of the voltage regulator, and a diode connected in series between an output terminal of the voltage regulator and an input terminal of the power amplifier module.

Preferably, the load switch is connected in parallel to an output terminal of the voltage regulator to switch the second voltage as the input to the power amplifier module when a radio signal is transmitted using a maximum output power.

Further, the first voltage used with the power amplifier module when transmitting a radio signal by a normal output power is preferably obtained by dropping the second voltage down to a particular level.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic diagram of a power switching device in a mobile communication terminal according to the related art;

FIG. 2 is a detailed schematic diagram of first and second load switches shown in FIG. 1;

FIG. 3 is a flowchart illustrating a power switching method in a mobile communication terminal according to the related art;

FIG. 4 is a schematic diagram of a power switching device in a mobile communication terminal according to an embodiment of the present invention;

FIG. 5 is a diagram comparing the power switching time of the related art and the present invention; and

FIG. 6 is a flowchart illustrating a power switching device in a mobile communication terminal according to the present invention.

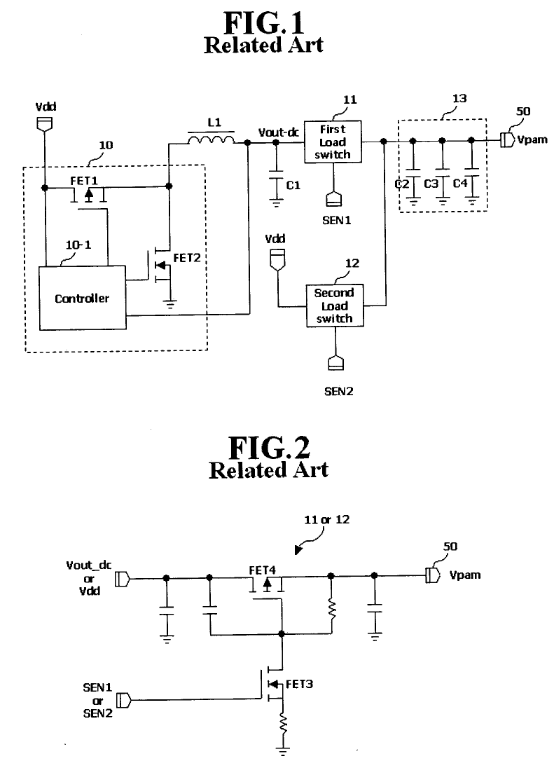

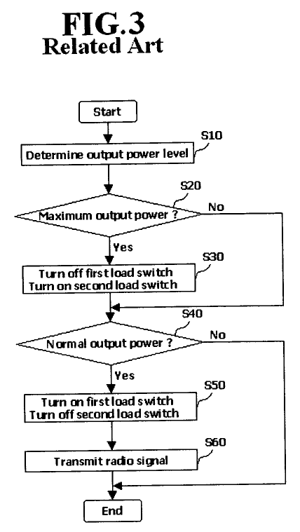

### DETAILED DESCRIPTION OF THE INVENTION

Reference will now be made in detail to preferred embodiments of the present invention, examples of which are illustrated in the accompanying drawings.

The present invention provides a novel power switching device that performs power switching more simply and at higher speed than that of the related art power switching circuit, and also removes reverse voltages and currents generated during a power switching operation, for example. Further, the present invention provides a novel power switching device by which power consumption of a mobile communication terminal is reduced and inner loop power control characteristics required for CDMA or WCDMA are satisfied.

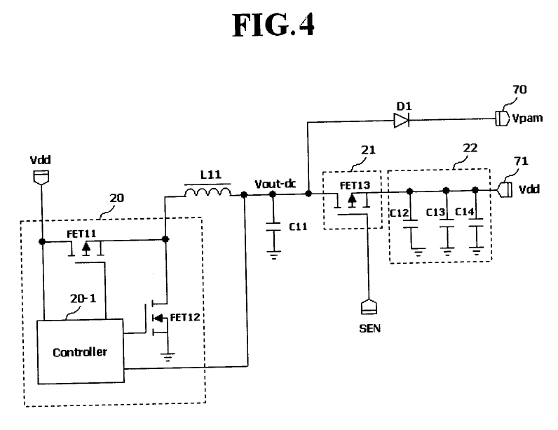

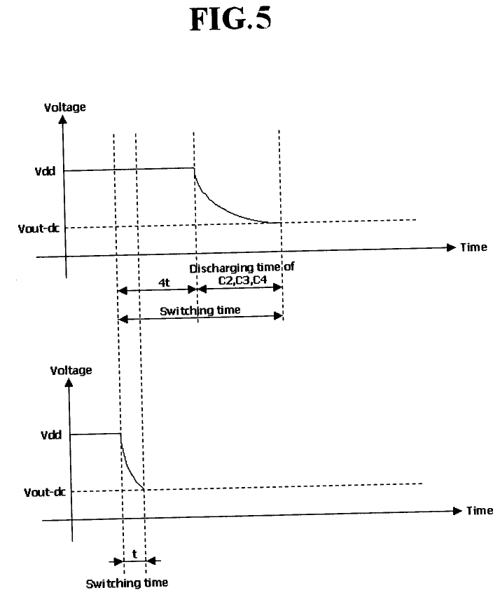

Turning now to FIG. 4, which is a schematic diagram of a power switching device in a mobile communication terminal according to an embodiment of the present invention. As shown, the power switching device includes a voltage regulator 20 for regulating a level of a battery voltage Vdd and for supplying the level-regulated battery voltage Vdd as a supply voltage Vpam of a power amplifier module PAM. Also included is a load switch 21 for supplying the battery voltage Vdd as the supply voltage Vpam of the PAM according to a switch enable signal SEN, a power decoupling unit 22 for removing noise from the battery voltage Vdd, and a diode D1 for removing a flow of reverse voltages generated at an output terminal 70 (i.e., an input terminal of the PAM) when performing a power switching operation.

As shown, the voltage regulator 20 includes two FETs (FET11 and FET12) and a controller 20-1, and regulates a level of the output voltage Vdd of the battery so as to generate an output voltage Vout-dc of 1.5V. The output voltage Vout-dc of 1.5V is supplied as the voltage Vpam of the PAM when a mobile communication terminal transmits radio signals using a normal output power, for example.

Further, the load switch 21 includes one switching FET 13 and switches the battery voltage Vdd into the PAM. The battery voltage Vdd is supplied as the voltage Vpam of the PAM when transmitting radio signals using a maximum output power, for example. As shown, the power decoupling unit 22 includes power decoupling capacitors C12 to C14 connected in parallel between the load switch 21 and an input terminal 71 of the battery voltage Vdd. In addition, reference symbols L11 and C11 refer to an inductor and a capacitor, respectively, which form a smoothing unit for smoothing the output voltage Vout-dc.

An operation of the power switching device according to the present invention will now be explained with reference to the accompanying drawings.

In the present invention, the power switching operation is performed by using only one load switch. That is, in the present invention, the output voltage Vout-dc of the voltage regulator 20 is directly supplied to the PAM, and the battery power Vdd of 4V is selectively supplied to the PAM through the load switch 21. Further, an operation of the load switch 21 is controlled by a switch enable signal SEN outputted from an MPU (MicroProcessor Unit).

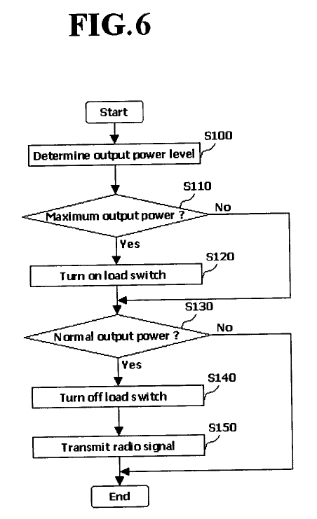

Turning next to the flowchart in FIG. 6. As shown, when transmitting radio signals from the mobile terminal to a base station, the MPU decides the particular level of a required output power according to a (physical) distance, for example, between the terminal and the base station (S100). When the terminal is far from the base station requiring signals be transmitted at a maximum output power (Yes in S110), the MPU outputs a switch enable signal SEN of a high level to turn on the FET13 of the load switch 21 (S120). Once the FET13 is turned on, the battery power Vdd of 4V is supplied as the voltage Vpam of the PAM via the load switch 21. In this instance, the power decoupling capacitors C12 to C14 of the power decoupling unit 22 are used to remove noise components from the battery voltage Vdd.

In contrast, when the terminal is (physically) close to the base station, for example, requiring signals to be transmitted at a normal output power, that is, when the power should be switched from Vdd to Vout-dc, the MPU outputs a switch enable signal SEN having a low level (i.e., logical LOW) so as to turn off the FET13 of the load switch 21. When the load switch 21 is turned off, the Vout-dc of 1.5V is supplied to the PAM. As a result and shown in FIG. 5, the voltage Vpam supplied to the PAM (i.e., the voltage of the output terminal 70 or an input terminal of the PAM), drastically drops from 4V to 1.5V. Further, the load switch 21 which has been turned off prevents any reverse currents (i.e., a reverse discharge toward the load switch) from being generated by the power decoupling capacitors C12 to C14. Therefore, when an on/off time of the FET 13 of the load switch 21 is ‘t’, as shown in FIG. 5, the power switching time according to the present invention can be reduced to approximately one fourth of 4t+(a discharging time of C2 to C4).

Furthermore, when the load switch 21 is turned off and the Vout-dc of 1.5V is supplied as the voltage Vpam of the PAM, the diode D1 provided at the output terminal 70 blocks any reverse voltage leaked toward the voltage regulator 20, which results in minimizing output distortions of the voltage regulator 20. Therefore, the PAM amplifies a radio signal according to the voltage Vpam supplied to the output terminal 70 by the power switching (Vdd→Vout-dc or Vout-dc→Vdd), namely, according to either the battery power Vdd of 4V or the Vout-dc of 1.5V, thereby allowing transmission of the amplified radio signal to the base station (S150 in FIG. 6). The examples above use Vdd of 4V and Vout-dc of 1.5V. However, other voltages may also be used.

As explained above, the present invention provides a novel power supply control device of a mobile communication terminal including a voltage regulator for receiving and processing an output of a power supply, and outputting a first output voltage for a PAM. Also included is a single load switch for receiving and processing the output of the power supply, and outputting a second output voltage for the PAM, and a microprocessor for controlling the voltage regulator and the single load switch to selectively provide the first output voltage or the second output voltage to the PAM via the voltage leakage blocker according to a signal transmission environment.

The voltage leakage blocker may be, for example, a diode that minimizes a reverse voltage leakage from reaching the voltage regulator. Also, the signal transmission environment can be based upon, for example, a physical location of the mobile communication terminal with respect to a base station or can be based upon a transmission channel condition.

Further, the signal transmission environment may be based upon a desired signal strength level regardless of the physical distance between the mobile communication terminal and a base station. For example, the desired signal strength necessary to achieve proper communications may be influenced because the user (having the mobile communication terminal) is on the move (i.e., the issue of mobility may be considered), or the environment may have many sources of potential signal interference (such as a crowded urban downtown area with many tall buildings, with large buildings, an underground location, etc.). Thus, depending upon the particular communication environment, the present invention can be applied to provided the desired switching of the output supply power for the mobile communication terminal.

As aforementioned, in the present invention, the power switching circuit has a simpler structure and a faster switching speed compared to that of the related art. Further, reverse currents from the power decoupling capacitor and reverse voltages generated from the output terminal can be effectively prevented from being generated when performing power switching according to the present invention.

In addition, in the present invention, power can be switched using only a single load switch compared to the more complicated two load switches in the related art, and accordingly the number of necessary control signals can be reduced. In addition, the manufacturing and maintenance costs can be effectively reduced compared with the related art.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A power switching device in a mobile communication terminal comprising:
a voltage regulator configured to generate a first voltage to be used as an input to a power amplifier module;
a battery configured to output a second voltage to be used as the input to the power amplifier module; and
a load switch configured to switch from using the first voltage to using the second voltage as an input to the power amplifier module based on an output power level of a transmit signal of the terminal.

2. The device of claim 1, further comprising a power decoupling unit connected between the battery and the load switch and configured to remove noise from the second voltage input into the load switch.

3. The device of claim 1, further comprising a smoothing unit connected at an output of the voltage regulator and configured to smooth an output voltage of the voltage regulator.

4. The device of claim 1, further comprising a diode connected in series between an output terminal of the voltage regulator and an input terminal of the power amplifier module.

5. The device of claim 1, wherein the load switch is connected in parallel to an output terminal of the voltage regulator.

6. The device of claim 1, wherein the load switch switches to using the second voltage as the input to the power amplifier module when transmitting radio signals at maximum output power.

7. The device of claim 1, wherein the first voltage is used as the input to the power amplifier module when transmitting radio signals at a normal output power, and wherein the first voltage is generated by dropping the second voltage down to a predetermined level.

8. The device of claim 1, wherein the load switch is a single load switch.

9. The device of claim 8, wherein the single load switch includes a single field effect transistor.

10. A power switching device in a mobile communication terminal comprising:
a voltage regulator configured to output a first voltage having a predetermined level to a power amplifier module;
a smoothing unit configured to smooth the output voltage of the voltage regulator;
a diode connected in series between an output terminal of the smoothing unit and an input terminal of the power amplifier module;
a load switch connected in parallel to an input terminal of the diode, and configured to switch from using the first voltage to using a second voltage from a battery as an input to the power amplifier module based an output power level of a transmit signal of the terminal; and
a power decoupling unit connected between the battery and the load switch and configured to remove noise from the second voltage input to the load switch.

11. The device of claim 10, wherein the load switch includes a single field effect transistor (FET), and the power decoupling unit includes at least one capacitor.

12. The device of claim 10, wherein the first voltage is input to the power amplifier module when transmitting radio signals at a normal output power.

13. The device of claim 10, wherein the load switch is switched so the second voltage is input to the power amplifier module when transmitting radio signals at a maximum output power.

14. The device of claim 10, wherein the load switch is a single load switch.

15. A power supply control device of a mobile communication terminal comprising:
a voltage regulator configured to receive and process an output of a power supply, and to output a first output voltage for a power amplifier module;
a single load switch configured to receive and process the output of the power supply, and to output a second output voltage for the power amplifier module; and
a microprocessor configured to control the voltage regulator and the single load switch to selectively provide the first output voltage or the second output voltage to the power amplifier module according to a signal transmission environment or transmit power of the terminal.

16. The device of claim 15, further comprising a voltage leakage blocker connected between the input of the power amplifier module and the voltage regulator and configured to reduce a reverse voltage leakage from reaching the voltage regulator.

17. The device of claim 16, wherein the voltage leakage blocker comprises a diode.

18. The device of claim 15, wherein the signal transmission environment is based upon a physical location of the terminal with respect to a base station.

19. The device of claim 15, wherein the signal transmission environment is based upon a transmission channel condition.

20. The device of claim 15, wherein the signal transmission environment is based upon a desired signal strength level regardless of the physical distance between the terminal and a base station.
